(19) United States
(12) Patent Application Publication
(10) Pub. No.: US 2016/0292635 A1
(43) Pub. Date: Oct. 6, 2016

(54) DELIVERY INSTRUCTIONS ON DELIVERY LOCATION DETECTION THROUGH A WIRELESS BEACON DEVICE

(71) Applicant: PAYPAL, INC., SAN JOSE, CA (US)

(72) Inventor: Michael Charles Todasco, Santa Clara, CA (US)

(21) Appl. No.: 14/673,746

(22) Filed: Mar. 30, 2015

(51) Int. Cl. G06Q 10/08; H04W 4/00; H04W 4/02

(52) U.S. Cl. CPC G06Q 10/0833; H04W 4/023; H04W 4/008

(57) ABSTRACT

There are provided systems and methods for delivery instructions on delivery location detection through a wireless beacon device. A merchant may include a wireless beacon, such as a small token or device, inside of a package for delivery. The beacon may communicate with other devices using short range wireless communications. The beacons may detect a location for the package, for example, through a GPS or mapping module, or may utilize the short range wireless communications with devices at a location to determine the package is in proximity to the location. When the location matches a delivery location for the package, delivery instructions for the package may be retrieved and presented to a delivery person in possession of the package. The delivery instructions may include an access code to access a building or property at the delivery location, a contact number for a recipient, or other delivery instruction.

### TECHNICAL FIELD

The present application generally relates to beacon transceiver devices and more specifically to delivery instructions on delivery location detection through a wireless beacon device.

### BACKGROUND

A user may purchase an item from an online merchant or over a phone connection with the merchant. The merchant may then ship the item to the user using a shipping provider, where the user supplies delivery information to the merchant to allow for delivery of the item. The shipping provider may allow for the merchant and/or the user to set delivery information, so that a delivery person is able to properly deliver the package. However, the merchant and/or the shipping provider may only allow for limited information to be entered to a shipping and delivery form, thus, not accounting for intricacies of delivery to certain users. For example, apartment buildings may require delivery to a resident services office so that the package is not left in a hallway where the package is susceptible to theft. Moreover, users living in gated communities or having another form of access required to access the users' property may wish to provide an access code to the property so that the package is delivered and is not left with an incorrect party. Even if the merchant and/or shipping provider allows for entry of such information, the delivery person may be required to search through records to find the correct information at every delivery, causing the delivery person delay and additional work.

### BRIEF DESCRIPTION OF THE DRAWINGS

FIG. 1 is a block diagram of a networked system suitable for implementing the processes described herein, according to an embodiment;

FIG. 2 is an exemplary environment showing delivery persons receiving delivery instructions on detection at or near a delivery location for a package through a wireless beacon and reuse of the wireless beacon for future shipping packages, according to an embodiment;

FIG. 3 is an exemplary system environment having a shipping provider server establishing delivery instructions for wireless beacons and utilizing merchant accounts for use of the wireless beacons and shipping, according to an embodiment;

FIG. 4 is a flowchart of an exemplary process for delivery instructions on delivery location detection through a wireless beacon device, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods that provide delivery instructions on delivery location detection through a wireless beacon device. Systems suitable for practicing methods of the present disclosure are also provided.

Various merchants may provide wireless beacons that utilize short range wireless communications with a device, such as using Bluetooth Low Energy (BLE), LTE Direct, or other communication protocol. These beacons may be added to a package for delivery. The beacons may communicate with devices in possession of a delivery person to communicate received and/or stored information to the delivery person, such as delivery instructions, through the short range wireless communications. The beacons may provide additional functionality, such as determining a location of the beacon and thus the package, for example, through a location detection module (e.g., a GPS module, mapping module, compass module, etc.) or through connections with other devices in proximity to the beacon through the short range wireless communications (e.g., communication devices of users and/or other wireless beacons established at the location).

A merchant may sell goods, products, and/or services (collectively referred to herein as an “item” or “items”) to users online or through phone communications. The merchant may further provide delivery of the items using a delivery service, such as a shipping provider that ships packages containing the item(s) to the user. The merchant and/or delivery service may place one or more of the aforementioned short range wireless beacons placed inside the package for delivery to the user, or otherwise associate the beacon with the package (e.g., on a delivery slip, connected to the package, etc.). These beacons may utilize short range wireless communications to communicate with a device in possession of a delivery person delivering the package to a specified delivery location by the user. The beacons may also utilize short range wireless communications to communicate with a device or beacon at the delivery location, such as a communication device for the user and/or a wireless beacon established at the location. In other embodiments, the beacons may include location detection modules (e.g., GPS, compass, etc.). The beacons may employ Bluetooth Low Energy (BLE), LTE Direct, or another communication protocol to emit a communication signal receivable by the delivery person's device. For example, the communication signal may include information stored on the beacon and/or received by the beacon over a network connection. The beacon may emit the short range wireless communication for access by all devices, including the delivery person's, may encrypt the communication using an encryption scheme known by the delivery person's device, or may share a communication link with the delivery person's device to communicate the information to the delivery person's device.

The beacon may also connect with the device/beacon at a location through a communication that may include an identifier for the beacon, the user, the merchant, and/or the delivery service administering the beacons. The user's device/beacon may be set up to passively monitor for BLE communications. When the device/beacon detects the signal and verifies the one or more identifiers, both the device/beacon at the location and the beacon associated with the package may ramp up in power and establish a connection, where the connection is used to generate location information that identifies the beacon, and thus the package, as in proximity to the connected device/beacon. Thus, the beacon may determine a location for the package using short range wireless communications with devices/beacons at or nearby locations. The connection may be completed automatically when the user's device/beacon is in range of the beacon associated with the package, or may be completed after prompting the user to connect with the beacon associated with the package when the user's device/beacon is in range of the package's beacon. In various embodiments, the delivery person's device may be set up in the same way to establish a communication link with the beacon associated with the package (e.g., placed in the package). The wireless beacon(s) may be range limited to only connect with devices and/or beacons within a certain distance of the package to determine how close the package is to a location (e.g., the delivery location), such as by limiting the signal strength of the beacon. Moreover, the beacon may also determine the location information using a location determination module of the beacon. The location information may be communicated to a server for processing, such as a server for the shipping provider, which may determine if the package is at or nearby a delivery location for the package. In other embodiments, the beacon may compare the location information to the delivery information having the delivery location to determine if the location of the package matches the delivery location.

Once the user's device (e.g., the communication device and/or other wireless beacon) connects to the beacon at the location, the location information from the connection may be used to determine if the package is at or nearby a delivery location for the package (e.g., within 50 feet, on the same street, etc.). The wireless beacon may include delivery instructions for the package associated with the wireless beacon. In other embodiments, the server for the shipping provider may determine the delivery instructions based on received delivery information. On detection of the location of the package matching the delivery location for the package, the server and/or the beacon may communicate the delivery instructions to a communication device for the delivery person in possession of the package. The delivery instructions may include a time for delivery of the package, a sub-location at the delivery location for delivery of the package, a recipient of the package at the delivery location, another delivery location for delivery of the package (e.g., a change of delivery locations), contact information for the recipient of the package at the delivery location, a drop-off location for the package within the delivery location, and an access code to access the delivery location.

The user and/or merchant may establish the delivery instructions in the delivery information, and may update the delivery instructions with information during shipment of the package. The shipping provider may also determine the delivery instructions based on information known about the user and/or delivery location. For example, the user may previous require an access code or the location may have a resident services office that accepts receipt of packages. Once the delivery instructions are determined, the shipping provider server may store the delivery instructions on the wireless beacon for communication to the delivery person's communication device on detection of the package at the delivery location, or may communicate the delivery instructions after receiving the location information matching the delivery location from the wireless beacon. The delivery person may then utilize the delivery instructions to deliver the package. In various embodiments, the delivery person's communication device may allow for contact of the user and/or recipient of the package at the delivery location, entry of an access code, and/or presentation of delivery instructions for access to a delivery location by a security guard.

Once the user receives and/or opens the package, the user may have access to the wireless beacon. The user may then access a shipping interface provided by the shipping provider server, such as through a web browser or dedicated application, which may allow the user to associate the wireless beacon with a new package for delivery, including a return package to the merchant or a package shipped to another user or merchant Thus, the beacon may be reused in another package and may be utilized to communicate delivery information for a recipient of the second package shipped by the user to a delivery person when delivering the second package. Where the beacon is shipped back to the merchant (e.g., in a return package), the merchant may receive their beacon for use in further shipments, as described above. However, if the beacon is shipped to another merchant or user, the first merchant may receive a shipping and/or beacon credit for loss of the beacon. The credit may be utilized with shipping with the shipping provider server, or may allow the first merchant to purchase, access, or otherwise receive further wireless beacons for use in packages.

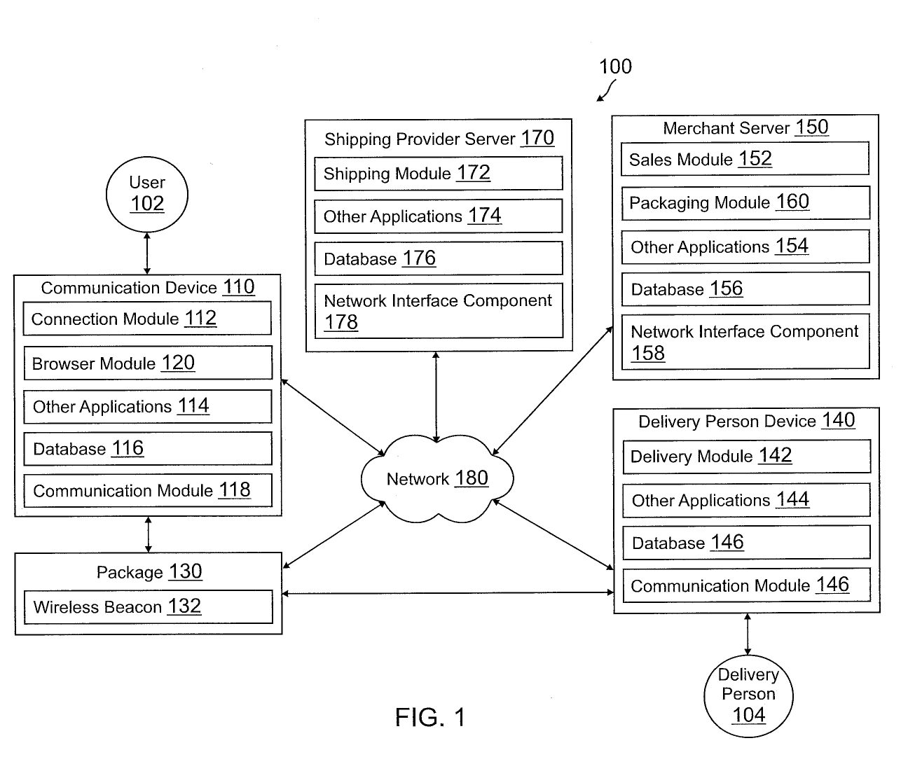

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary device and servers may include device, stand-alone, and enterprise-class servers, operating an OS such as a MICROSOFT® OS, a UNIX® OS, a LINUX® OS, or other suitable device and/or server based OS. It can be appreciated that the devices and/or servers illustrated in FIG. 1 may be deployed in other ways and that the operations performed and/or the services provided by such devices and/or servers may be combined or separated for a given embodiment and may be performed by a greater number or fewer number of devices and/or servers. One or more devices and/or servers may be operated and/or maintained by the same or different entities.

System 100 includes a user 102, a delivery person 104, a communication device 110, a package 130 having a wireless beacon 132, a delivery person device 140, a merchant server 150, and a shipping provider server 170 in communication over a network 180. User 102, such as a consumer, may purchase one or more items from a merchant corresponding to merchant server 150. The merchant may utilize shipping provider server 170 to ship package 130 having wireless beacon 132. User 102 and/or the merchant may establish delivery information for package 130 with shipping provider server 170, including a delivery location for package 130. The delivery information may include or be used to determine delivery instructions for package 130. Wireless beacon 132 may determine a location for package 130, for example, using connections with another beacon/device (e.g., communication device 110) and/or through a location detection module. Once the location for package 130 matches the delivery location for package 130, the delivery instructions may be communicated to delivery person device 140 for viewing by delivery person 104 and/or use in delivery of package 130.

Communication device 110, wireless beacon 132, delivery person device 140, merchant server 150, and a shipping provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 180.

Communication device 110 may be implemented using any appropriate hardware and software configured for wired and/or wireless communication with wireless beacon 132, delivery person device 140, merchant server 150, and/or shipping provider server 170. For example, in one embodiment, communication device 110 may be implemented as a personal computer (PC), a smart phone, laptop/tablet computer, wristwatch with appropriate computer hardware resources, eyeglasses with appropriate computer hardware (e.g. GOOGLE GLASS ®), other type of wearable computing device, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

Communication device 110 of FIG. 1 contains a connection module 112, a browser module 120, other applications 114, a database 116, and a communication module 118. Connection module 112, browser module 120, and other applications 114 may correspond to executable processes, procedures, and/or applications with associated hardware, for example, a device module. In other embodiments, communication device 110 may include additional or different software as required.

Connection module 112 may correspond to one or more processes to execute modules and associated devices of communication device 110 to establish a connection with wireless beacon 132 in proximity to communication device 110 through short range wireless communications so that wireless beacon 132 may generate location information identifying wireless beacon 132 (and thus package 130) as in proximity to communication device 110 and user 102 in possession of communication device 110. In this regard, connection module 112 may correspond to specialized hardware and/or software utilized by communication device 110 to establish a connection with wireless beacon 132, for example, through a specific application and communication protocols utilized by communication device 110 with wireless beacon 132. In various embodiments, connection module 112 may receive short range wireless communications from wireless beacon 132 when package 130 is in proximity to communication device 110 and transmit information to wireless beacon 132, including an identifier for user 102 and/or communication device 110 allowing wireless beacon 132 and/or shipping provider server 170 to identify the location for wireless beacon 132 (e.g., by using the identifier to identify user 102 and/or communication device 110). In other embodiments, connection module 112 may transmit location information to wireless beacon 132, such as an address stored to communication device 110 or other location of user 102, GPS coordinates determined by communication device 110, etc.

Wireless beacon 132 may be range limited to connect only with devices (e.g., communication device 110) within a specified area, such as a radius around wireless beacon 132. In various embodiments, wireless beacon 132 may be placed inside, on, or connected to package 130, or connected to a packaging slip, delivery notice, or other paperwork associated with package 130. Thus, communication device 110 may connect to wireless beacon 132 when communication device 110 is within a distance or radius around package 130. Based on the proximity for connection to wireless beacon 132, connection module 112 may transmit information (e.g., identifier, location information, etc.) to wireless beacon 132 when user 102 is nearby wireless beacon 132. In further embodiments, connection module 112 may also retrieve additional delivery instruction stored to communication device 110 and communicate those instructions to wireless beacon 132. Such instructions may include a location for user 102 at the delivery location, a change in delivery instructions, a contact address or other information for user 102, or other information stored to communication device 110 and used for delivery of package 130. Moreover, a wireless beacon established at a delivery location may utilize similar processes described above in reference to connection module 112 to connect with wireless beacon 132 allowing for detection of a location of wireless beacon 132 and/or communicating delivery instructions to wireless beacon 132 for presentation to delivery person 104 on delivery person device 140. In other embodiments, wireless beacon 132 may determine a location for wireless beacon 132 through other modules of wireless beacon 132, such as a location detection module as discussed herein.

Connection module 112 may execute in the background of an operating system of communication device 110 and be configured to establish connections, using communication module 118 of communication device 110, with wireless beacon 132. The connection may be established with or without user input from user 102. For example, wireless beacon 132 may broadcast a token, such as a universally unique identifier (UUID), for reception by connection module 112, as will be explained in more detail herein. Connection module 112 may utilize communication module 118 of communication device 110 to receive the token from wireless beacon 132. If connection module 112 acknowledges the UUID as identifying wireless beacon 132, delivery person device 140, merchant server 150, and/or shipping provider server 170 (e.g., if connection module 112 determines the UUID corresponds to a request to establish a communication channel), connection module 112 may transmit an identifier, location information, additional delivery information, and/or other information corresponding to delivery of package 130 back to wireless beacon 132. Connection module 112 may utilize communication module 118 of communication device 110 to communicate with wireless beacon 132 (e.g., over near field communication, Bluetooth, Bluetooth Low Energy, radio, infrared, LTE Direct, or other communication protocol). The replied information from communication device 110 may include, be transmitted with, concatenated with, or otherwise bundled with the identifier received from wireless beacon 132. In other embodiments, different information may be transmitted to wireless beacon 132, such as a name or other personal information for user 102 or other identifying information. Once a connection is established with wireless beacon 132, location information for wireless beacon 132 may be determined and used to determine if delivery person device 140 should receive delivery instructions for package 130.

Browser module 120 may correspond to one or more processes to execute modules and associated devices of communication device 110 to provide a web browser, which may send and receive information over network 180, including retrieving website information (e.g., webpages and webpage data, such as interfaces and elements for accepting input) and communicating information to a website. In this regard, browser module 120 may correspond to specialized hardware and/or software utilized by communication device 110 to provide a convenient interface to permit user 102 to browse the Internet, including navigation to websites and between webpages of websites, such as a website of shipping provider server 170. Browser module 120 may therefore be configured to transmit and receive information, such as webpage requests, input to webpages, downloads and uploads of data in database 116 of communication device 110, etc. In various embodiments, browser module 120 may be used to associate wireless beacon 132 with a new package for shipping by user 102 to another user, the same merchant (e.g., the merchant associated with merchant server 150), and/or another merchant. For example, browser module 120 may receive a shipping interface for a shipping module of merchant server 150, which may be utilized to associate wireless beacon 132 with a new package (e.g., through an identifier for wireless beacon 132 and shipping and delivery information for the new package). In other embodiments, the shipping interface present through browser module 120 may reprogram wireless beacon 132 with new shipping and delivery information for the new package, as explained herein. Thus, user 102 may utilize browser module 120 to enter information to merchant server 150 and/or shipping provider server 170, such as shipping information (e.g., a type of shipping selected), delivery information (e.g., a delivery address or other location) and/or delivery instructions (e.g., a time for delivery, an access code at the delivery location, etc.). The entered information may then be used when shipping wireless beacon 132 with the new package (e.g., inside, attached to, etc.). In other embodiments, browser module 120 may execute a dedicated application for shipping provider server 170 to provide the interface and reuse wireless beacon 132 with a new package for shipment.

In various embodiments, one or more features of connection module 112 and browser module 120 may be incorporated in the same application so as to provide their respective features in a similar application.

Communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over a network, or other types of applications. Other applications 114 may also include email, texting, voice and IM applications that allow a user to send and receive emails, calls, texts, and other communications over a network. In various embodiments, other applications 114 may include financial applications, such as banking, online payments, money transfer, or other applications associated with a payment provider and used to provide payment, such as payment for shipping costs and/or purchase of items. Other applications 114 may include GPS, compass, mapping, social networking, calendaring, and other applications, which may also be used in conjunction with connection module 112 and/or browser module 120 in order to facilitate delivery of package 130, such as providing location information to wireless beacon 132 and/or updating delivery instructions. Other applications 114 may contain software programs, executable by a processor, including a graphical user interface (GUI) configured to provide an interface to the user.

Communication device 110 may further include database 116 which may include, for example, identifiers such as operating system registry entries, cookies associated with connection module 112, browser module 120, and/or other applications 114, identifiers associated with hardware of communication device 110, or other appropriate identifiers, such as identifiers used for user/device identification. Identifiers in database 116 may be transmitted to wireless beacon 132 as identification for user 102 and/or communication device 110. Database 116 may include user device tokens and/or encryption keys, including an encryption key of wireless beacon 132, delivery person device 140, merchant server 150, and/or shipping provider server 170. Database 116 may include identifying information for tokens enabling connection module 112 to identify wireless beacon 132, delivery person device 140, merchant server 150, and/or shipping provider server 170 when receiving a corresponding token. In various embodiments, database 116 may store information used by connection module 112 and/or browser module 120, including location information, delivery instructions, and/or new shipping and delivery information.

Communication device 110 includes at least one communication module 118 adapted to communicate with wireless beacon 132, delivery person device 140, merchant server 150, and/or shipping provider server 170. In various embodiments, communication module 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 118 may communicate with wireless beacon 132 using short range communications, such as Bluetooth Low Energy, LTE Direct, WiFi, radio frequency, infrared, Bluetooth, and near field communications.

Package 130 may correspond to a physical item or container for delivery to a user, such as user 102. Thus, package 130 may include shipping containers, packages, and/or other objects used to ship and deliver an item to the user. Package 130 may further include wireless beacon 132, which may be located inside, attached to, or connected to package 130. Wireless beacon 132 may include hardware and software necessary to execute the processes and functions as described below. In other embodiments, package 130 may include additional hardware and/or software as required to process the above and below described features offered by package 130.

Wireless beacon 132 may be maintained, for example, by a merchant corresponding to package 130/merchant server 150 or by a shipping provider corresponding to shipping provider server 170. Wireless beacon 132 may be implemented using any appropriate hardware and software configured for wireless communication with communication device 110. For example, wireless beacon 132 may act as a stand-alone device including a processor, memory, communication module, and/or network interface component configured to communicate with communication device 110, delivery person device 140, and/or shipping provider server 170. Wireless beacon 132 may be limited, either by signal range or physical boundaries, to nearby package 130, for example, a range for delivery of package 130 and/or retrieval of package 130 by delivery person 140 during delivery of package 130.

Wireless beacon 132 of FIG. 1 contains processes, procedures, and/or applications, for example, a software program, executable by a hardware processor configured to interact with communication device 110, delivery person device 140, merchant server 150 and/or shipping provider server 170. Thus, regardless of the implementation of wireless beacon 132 as discussed above, wireless beacon 132 may utilize a connection process and/or a location determine module and include or be connected to a communication module used to communicate location information to shipping provider server 170 and/or communicate delivery instructions to delivery person device 140. In other embodiments, wireless beacon 132 may include additional or different hardware and software as required.

Wireless beacon 132 may include an application for transmitting requests to establish a connection between a device (e.g., communication device 110 and/or delivery person device 140) and wireless beacon 132. The requests may be unique to wireless beacon 132, thereby identifying wireless beacon 132 and package 130. Wireless beacon 132 may utilize short range wireless communications of wireless beacon 132 to transmit the requests to establish a connection, including an identifier such as a Universally Unique Identifier (UUID). If communication device 110 and/or delivery person device 140 receives a request to establish the connection with wireless beacon 132 and responds with an identifier (potentially including the UUID and other information necessary to effectuate a connection), wireless beacon 132 may ramp up in power and create a connection between communication device 110/delivery person device 140 and wireless beacon 132.

Wireless beacon 132 may transmit the request to establish the connection with wireless beacon 132 as a short range wireless communication (e.g. a BLE protocol communication) including a “wake up” process for communication device 110/delivery person device 140 and/or a token for wireless beacon 132 transmitting the request. In other embodiments, the request and/or connection may utilize near field communication, radio communication, infrared communication, or Bluetooth communication. Additionally, although wireless beacon 132 may utilize BLE protocol communications to effectuate an “always on” type service where the UUID and “wake up” process are transmitted continuously, other communication protocols used to provide an “always on” service may include QUALCOMM® LTE Direct or similar device-to-device communication technology. BLE and LTE Direct may both be utilized to provide discovery of nearby devices to wireless beacon 132 (e.g., communication device 110/delivery person device 140) and establishment of a connection for data transfers. In other embodiments, wireless beacon 132 may correspond to other devices, such as WiFi capable devices, near field communication devices, etc. In various other embodiments, wireless beacon 132 may generally communicate information, such as delivery instructions, on detection of wireless beacon 132 at a location at or nearby (e.g., matching) a delivery location for package 130 for reception by delivery person device 140, which may be encrypted or unencrypted. Moreover, wireless beacon 132 may keep a communication link open with delivery person device 140 for communication of information, or may use known identifier for delivery person device 140 for communication of the information.

Wireless beacon 132 may determine a location for wireless beacon 132 using connections with communication device 110 and/or another wireless beacon established at a location. For example, after forming a connection with another device/beacon through short range wireless communications, wireless beacon 132 may determine that wireless beacon 132 and thus package 130 is in proximity to the device/beacon. Using known location information for the device/beacon, wireless beacon 132 may then determine a location for wireless beacon 132 and package 130. In other embodiments, wireless beacon 132 may receive location information from the device/beacon through the connection (e.g., GPS coordinates, an address, etc.). However, in other embodiments, wireless beacon 132 may include a location discovery/detection module, such as a GPS module, a mapping or compass module, or other type of location module. Wireless beacon 132 may determine a location for wireless beacon 132 and package 130 using the module.

Using the location information for wireless beacon 132 and package 130, it may be determined whether package 130 is at or nearby a delivery location for package 130, such as within a certain proximity for the delivery location (e.g., 50 feet), on the same street, within the same building, in the same community, etc. In various embodiments, wireless beacon 132 may determine whether the location matches the delivery location. However, in other embodiments, the location information may be communicated to shipping provider server 170 for determination of whether the location matches the delivery location. Once a determination has been made that the location matches the delivery location, delivery instructions for package 130 may be communicated to delivery person device 140 for presentation to delivery person 104.

Wireless beacon 132 may utilize a connection with delivery person device 140 to communicate delivery instructions to delivery person device 104. In various embodiments, wireless beacon 132 may store delivery instructions for communication to delivery person device 140 on detection of wireless beacon 132 at or nearby the delivery location for package 130. In other embodiments, wireless beacon 132 may receive the delivery instruction from shipping provider server 170 on detection of wireless beacon 132 at or nearby the delivery location for package 130 or shipping provider server 170 may communicate the delivery instructions directly to delivery person device 140.

In various embodiments, wireless beacon 132 may be utilized in shipping a new package after wireless beacon 132 is removed from package 130. Thus, user 102 may reprogram wireless beacon 132, as discussed herein. Wireless beacon 132 may then store new delivery instructions for presentation to a delivery person on detection of wireless beacon 132 at or nearby the new delivery location. In various embodiments, wireless beacon 132 may also store the delivery information for the new package shipped by user 102, for example, where wireless beacon 132 determines that a location for wireless beacon 132 matches the delivery location.

Wireless beacon 132 may utilize a communication module to pass the location information, delivery information and/or delivery instructions to delivery person device 140 and/or shipping provider server 170. Moreover, wireless beacon 132 includes a communication module adapted to communicate with communication device 110, delivery person device 140, merchant server 150 and/or shipping provider server 170. The communication module may include a DSL (e.g., Digital'Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. The communication module of wireless beacon 132 may also communicate with communication device 110 and/or delivery person device 140 using short range communications, such as Bluetooth Low Energy, LTE Direct, WiFi, radio frequency, infrared, Bluetooth, and near field communications.

Delivery person device 140 may correspond to a device used by delivery person 104 to receive delivery instructions on detection of package 130 at or nearby a delivery location for package 130. Delivery person 104 may correspond to an employee of shipping provider server 170 who may deliver package 130 to a location specified in delivery information for package 130. Thus, delivery person device 140 may be located locally to package 130, such as on the person of delivery person 104. Delivery person device 140 may be implemented using any appropriate hardware and software configured for wired and/or wireless communication with communication device 110, wireless beacon 132, merchant server 150, and/or shipping provider server 170. For example, delivery person device 140 may be implemented as a personal computer (PC), a smart phone, laptop computer, wristwatch with appropriate computer hardware resources, eyeglasses with appropriate computer hardware (e.g. GOOGLE GLASS ®), other type of wearable computing device, and/or other types of computing devices capable of transmitting and/or receiving data, such as an IPAD® from APPLE®. Although a device is shown, the device may be managed or controlled by any suitable processing device. Although only one device is shown, a plurality of devices may function similarly.

Delivery person device 140 of FIG. 1 contains a delivery module 142, other applications 144, a database 146, and a communication module 148. Delivery module 142 and other applications 144 may correspond to processes, procedures, and/or applications, for example, a software program, executable by a hardware processor. In other embodiments, delivery person device 140 may include additional or different software as required.

Delivery module 142 may correspond to one or more processes to execute modules and associated devices of delivery person device 140 to receive delivery instructions on detection of package 130 at or nearby a delivery location for package 130 using location information determined by wireless beacon 132 and display the delivery instructions to delivery person 140 through an interface. In this regard, delivery module 142 may correspond to specialized hardware and/or software utilized by delivery person device 140 to connect to wireless beacon 132 and display an interface to delivery person 104 for use in delivering package 130 to a location. In various embodiments, delivery module 142 may utilize connection processes similar to connection module 112 of communication device 110 to connect with wireless beacon 132 and receive delivery instructions over a communication link with wireless beacon 132. However, in other embodiments, wireless beacon 132 may generally broadcast encrypted or unencrypted delivery instructions using short range wireless communications for receipt by delivery module 142 and presentation to delivery person 104. Moreover, in other embodiments, delivery module 142 may receive the delivery instructions from shipping provider server 170 over network 180.

Once the delivery instructions are received by delivery module 142, delivery module 142 may display the delivery instructions to delivery person 104 through an interface. The interface may display any instructions and associated information (e.g., maps, photographs, etc.) to delivery person 104, such as a recipient, a drop off location, etc. Delivery module 142 may also allow for use of the delivery instructions with another application or module of delivery person device 140. For example, a contact address, phone number, messenger name, etc., may be utilized to contact the recipient. In other embodiments, a physical address may be utilized with a mapping application, a photograph may be utilized with a facial recognition application (e.g., enabling identification of the recipient), or other delivery instruction may be utilized with other modules of delivery person device 140.

Delivery person device 140 includes other applications 144 as may be desired in particular embodiments to provide features to delivery person device 140. For example, other applications 144 may include security applications for implementing client-side security features, programmatic client applications for interfacing with appropriate application programming interfaces (APIs) over network 180, or other types of applications. In various embodiments, other applications 144 may include shipping and/or payment application associated with shipping provider server 170. Other applications 144 may contain other software programs, executable by a processor, including a graphical user interface (GUI) configured to provide an interface to the user.

Delivery person device 140 may further include database 146 which may include, for example, identifiers such as operating system registry entries, cookies associated with delivery module 142 and/or other applications 144, identifiers associated with hardware of delivery person device 140, or other appropriate identifiers, such as identifiers used for user/device authentication or identification. Database 146 may also store user 102's delivery information and/or delivery instructions.

Delivery person device 140 includes at least one communication module 148 adapted to communicate with communication device 110, wireless beacon 132, merchant server 150, and/or shipping provider server 170. In various embodiments, communication module 148 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. Communication module 148 may communicate directly with wireless beacon 132 using short range communications, such as Bluetooth Low Energy, LTE Direct, radio frequency, infrared, Bluetooth, and near field communications.

Merchant server 150 may be maintained, for example, by a merchant or other online retailer, which may provide item sales and delivery of purchased items to users, such as user 102. In this regard, merchant server 150 includes one or more processing applications which may be configured to interact with communication device 110, wireless beacon 132, delivery person device 140, and/or shipping provider server 170 to facilitate sales and delivery of items. In one example, merchant server 150 may be provided by EBAY®, Inc. of San Jose, Calif., USA. However, in other embodiments, merchant server 150 may be maintained by or include another merchants and online retailers, which may provide item sales and delivery. Moreover, in various embodiments, one or more of the applications, processes, and/or features discussed below in reference to merchant server 150 may be included in shipping provider server 170 (e.g., packaging module 160), and vice versa.

Merchant server 150 of FIG. 1 includes a sales module 152, a packaging module 160, other applications 154, a database 156, and a network interface component 158. Sales module 152, packaging module 160, and other applications 154 may correspond to processes, procedures, and/or applications, for example, a software program, executable by a hardware processor. In other embodiments, merchant server 150 may include additional or different software as required, such as a check-in application, which may provide a check-in for communication device 110 when communication device 110 connects to wireless beacon 132.

Sales module 152 may correspond to one or more processes to execute modules and associated devices of merchant server 150 to provide a sales and/or marketplace interface permitting user 102 to browse items for sale from a merchant corresponding to merchant server 150 and purchase items from the merchant for delivery to user 102 using a shipping provider associated with shipping provider server 170. In this regard, sales module 152 may correspond to specialized hardware and/or software utilized by merchant server 150 to transmit the interface over network 180 to communication device 110 for display to user 102, for example, using browser module 120. The interface may enable user 102 to view items for sale from the merchant and select one or more items for purchase. After selecting items for purchase, sales module 152 may be utilized to complete a transaction for the selected item(s), for example, by providing one or more payment instruments to merchant server 150. In various embodiments, the payment instrument may correspond to a payment account provided by a payment service provider, such as PAYPAL®, Inc. of San Jose, Calif. Once the payment instrument is processed, the financial transaction may be completed.

During or after completion of the financial transaction for the one or more items, user 102 may provide shipping and delivery information for the purchased item(s). The shipping information may correspond to a method for shipping (e.g., a type, length of time, etc.). The delivery information may include an address for delivery, such as a delivery location, and may include in various embodiments delivery instructions on arrival at the delivery location by delivery person 104. The item(s) may be shipped in package 130, as discussed herein. Thus, the delivery location address may correspond to an address for user 102 (e.g., home, work, etc.) or may correspond to an address of another user receiving package 130 (e.g., a friend receiving a present from user 102). Delivery instructions may further correspond to information provided of one or more eligible receivers for package 130, such as information identifying user 102 and other users that user 102 designates as eligible to receive package 130. The delivery instructions may include names, phone numbers, email addresses, identifiers, or other identification information enabling identification of the users. Further delivery instructions may include access codes to access property, drop-off locations on a property, a time or times for delivery, a change of delivery location, and/or a sub-location within a delivery location for delivery (e.g., a desk clerk, front office, etc.). After providing the aforementioned shipping information, delivery information, and/or delivery instructions, merchant server 150 may utilize packaging module 160 to prepare package 130 including wireless beacon 132.

Packaging module 160 may correspond to one or more processes to execute modules and associated devices used by merchant server 150 to package and ship package 130 including wireless beacon 132. In this regard, packaging module 160 may correspond to specialized hardware and/or software utilized by merchant server 150 to work with shipping provider server 170 to arrange for pickup, shipping, and delivery of package 130. Packaging module 160 may receive the item(s) for delivery to user 102 and arrange for package 130 to package the items and initiate shipping of the items. Thus, packaging module 160 may determine and arrange for creation of package 130 containing the items. Once the items have been selected and are ready for packaging, packaging module 160 may further arrange for utilizing wireless beacon 132 with package 130. In this regard, packaging module 160 may have a wireless beacon placed into package 130, attached to package 130, and/or otherwise connected or corresponding to package 130. Packaging module 160 may program wireless beacon 132 with delivery instructions from sales module 152, such as by storing the delivery instructions to a database of wireless beacon 132 for communication to delivery person device 140 on detection of package 130 at or nearby a delivery location (e.g., through location information determined by wireless beacon 132). In other embodiments, packaging module 160 may provide the delivery instructions to shipping provider server 170 for communication to delivery person device 140, for example, stored to delivery person device 140 and/or communicated to delivery person device 140 on detection of package 130 at or nearby the delivery location. As previously discussed, packaging module 160 may also access an interface for shipping provider server 170 to view a merchant shipping account, which may include credits for loss of use of wireless beacon 132 (e.g., shipping and/or beacon purchase credits). Packaging module 160 may also be used to reprogram and/or reuse a wireless beacon, for example, if wireless beacon 132 is returned to the merchant associated with merchant device 150.

In various embodiments, merchant server 150 includes other applications 154 as may be desired in particular embodiments to provide features to merchant server 150. For example, other applications 154 may include security applications for implementing server-side security features, programmatic server applications for interfacing with appropriate application programming interfaces (APIs) over network 180, or other types of applications. Other applications 154 may contain software programs, executable by a processor, including a graphical user interface (GUI), configured to provide an interface to a user.

Additionally, merchant server 150 includes database 156. User 102 may establish one or more purchase and payment accounts with merchant server 150. User accounts in database 156 may include user information, such as name, address, birthdate, payment/funding information, additional user financial information, and/or other desired user data. The user account information may be used to determine shipping and/or delivery information (and delivery instructions), which may be communicated to shipping provider server 170. In other embodiments, user 102 may link to their respective account through a user and/or device identifier. Thus, when an identifier is transmitted to merchant server 150 (e.g. from wireless beacon 132), an account belonging to user 102 may be found. In other embodiments, user 102 may not have previously established an account and may provide other identification information to merchant server 150, as previously discussed. Database 156 may further include information provided to merchant server 150 for delivery of package 130.

In various embodiments, merchant server 150 includes at least one network interface component 158 adapted to communicate with communication device 110, wireless beacon 132, delivery person device 140, and/or shipping provider server 170 over network 180. In various embodiments, network interface component 158 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Shipping provider server 170 may be maintained, for example, by a service provider, which may provide pickup, shipping, and delivery services for one or more items purchased from merchant server 150. In this regard, shipping provider server 170 includes one or more processing applications which may be configured to interact with communication device 110, wireless beacon 132, merchant server 150, and/or delivery person device 140 to facilitate the pickup, shipping, and delivery of the item(s) using package 130 having wireless beacon 132. Shipping provider server 170 may be maintained by or include a merchant, marketplace provider, financial services provider, and/or other service provider, which may provide shipping services to user 102 and/or the merchant corresponding to merchant server 150 (e.g., through delivery person 104). In various embodiments, one or more of the applications, processes, and/or features discussed below in reference to shipping provider server 170 may be included in merchant server 150 (e.g., shipping module 172), and vice versa.

Shipping provider server 170 of FIG. 1 includes a shipping module 172, other applications 174, a database 176, and a network interface component 178. Shipping module 172 and other applications 174 may correspond to processes, procedures, and/or applications, for example, a software program, executable by a hardware processor. In other embodiments, shipping provider server 170 may include additional or different software as required.

Shipping module 172 may correspond to one or more processes to execute modules and associated devices of shipping provider server 170 to receive information from merchant server 150 used for delivery of package 130 and arrange for shipping and delivery of package 130. In this regard, packaging module 160 may correspond to specialized hardware and/or software utilized by merchant server 150 to receive shipping information, delivery information, and/or delivery instructions from merchant server 150 and arrange for pickup, shipping, and/or delivery of package 130 using the information and/or instructions. The delivery information may include a name and address for delivery of package 130. As discussed herein, merchant server 150 may provide information to shipping module 172 for use with delivery of package 130, which may include delivery instructions for presentation to delivery person 104 through delivery person device 140. However, in other embodiments, shipping module 172 may determine delivery instructions after receiving a recipient for package 130, delivery information (e.g., a delivery location) for package 130, and/or other information, including merchant information. Shipping module 172 may determine the delivery instructions passed on past delivery histories to the user and/or the location as well as other known or accessible information about the user and/or location. For example, shipping module 172 may have a previously stored gate access code to a property, community, or building used for the delivery instructions. Shipping module 172 may also access work times for user 102 to consider delivery around or during a work time. Shipping module 172 may also have previous delivery instructions for user 102, which may be used to determine current delivery instructions. Such information may be available based on information stored to database 176 for previous deliveries and/or accessible from one or more third party resources, including scraping such information from a social networking profile, micro-blogging post, and/or other online resource.

Once the delivery instructions are received and/or determined, shipping module 172 may utilize the delivery instructions on detection of package 130 at or nearby the delivery location specified for package 130 through location information for wireless beacon 132. The delivery instructions may be stored to wireless beacon 132 or database 176. Thus, one or more of wireless beacon 132 and/or shipping module 172 may communicate the delivery instructions when location information for wireless beacon 132 matches the delivery location for package 130. Thus, shipping module 172 may also be used to determine whether location information for wireless beacon 132 matches delivery information for package 130 (e.g., within a certain distance, in the same building, on the same street, etc.). Shipping module 172 may receive updates to the delivery location during transit of package 130, which may be updated in database 176 and/or communicated to wireless beacon 132 for updating.

As previously discussed, an interface for reuse of wireless beacon 132 may be provided by shipping module 172 to user 102. Thus, shipping module 172 may further be utilized to clear previous delivery information and/or delivery instructions for wireless beacon 132 and enter new information. Shipping module 172 may receive the identification and/or access information (e.g., an access code to wireless beacon 132 allowing for reuse of wireless beacon 132) and enable user 102 to view and erase the previous info nation for wireless beacon 132. The previous information may be erased from wireless beacon 132, or from merchant server 150/shipping provider server 170. User 102 may then utilize browser module 120 with shipping module 172 to enter new delivery information and/or instructions for a new package user 102 wishes to ship. Thus, shipping module 172 may provide a user interface enabling user 102 to enter wireless beacon 132 information and/or new delivery information. After entering new information, shipping module 172 may verify the new information and/or authorize the new information with user 102. Shipping module 172 may then transmit the new information for storage by wireless beacon 132 or may store the new information to database 176.

In various embodiments, shipping provider server 170 includes other applications 174 as may be desired in particular embodiments to provide features to shipping provider server 170. For example, other applications 174 may include security applications for implementing server-side security features, programmatic server applications for interfacing with appropriate application programming interfaces (APIs) over network 180, or other types of applications. Other applications 174 may contain software programs, executable by a processor, including a graphical user interface (GUI), configured to provide an interface to a user.

Additionally, shipping provider server 170 includes database 176. As previously discussed, user 102 and/or merchant server 150 may establish one or more shipping accounts with shipping provider server 170. User accounts in database 176 may include merchant/user information, such as name, address, birthdate, payment/funding information, shipping and/or delivery information, specific delivery instructions, additional user financial information, and/or other desired user data. User 102 and/or the merchant may link to their respective shipping accounts through a user, merchant, and/or device identifier. The accounts may be used when shipping an item, such as through payment of shipping costs and/or determination of identification and/or recipient information. Database 176 may further include additional information, such as information for wireless beacon 132, including access and/or identification information, as well as shipping and/or delivery information for recipients not having a prior account established with shipping provider server 170.

In various embodiments, shipping provider server 170 includes at least one network interface component 178 adapted to communicate with communication device 110, wireless beacon 132, delivery person device 140, and/or merchant server 170 over network 180. In various embodiments, network interface component 178 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 180 may be implemented as a single network or a combination of multiple networks. For example, in various embodiments, network 180 may include the Internet or one or more intranets, landline networks, wireless networks, and/or other appropriate types of networks. Thus, network 180 may correspond to small scale communication networks, such as a private or local area network, or a larger scale network, such as a wide area network or the Internet, accessible by the various components of system 100.

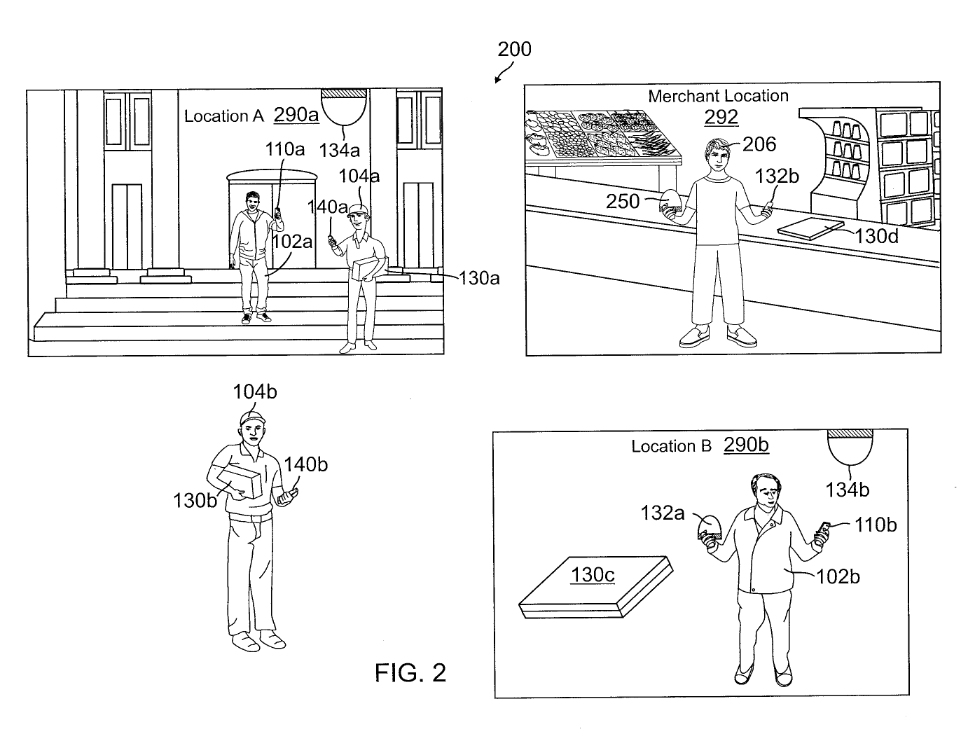

FIG. 2 is an exemplary environment showing delivery persons receiving delivery instructions on detection at or near a delivery location for a package through a wireless beacon and reuse of the wireless beacon for future shipping packages, according to an embodiment. Environment 200 of FIG. 2 includes a user 102a having a communication device 210a and a user 102b having a communication device 210b both corresponding generally to user 102 having communication device 110, respectively, of FIG. 1. Additionally, environment 200 includes a package 130a, a package 120b, a package 130c, and a package 130d all corresponding generally to package 130 of FIG. 1. Environment 200 further includes a wireless beacon 132s and a wireless beacon 132b both corresponding generally to wireless beacon 132 of FIG. 1, and a delivery person 104a having a delivery person device 140a and a delivery person 104b having a delivery person device 140b both corresponding generally to delivery person 104 and delivery person device 140, respectively, of FIG. 1.

Environment 200 includes 3 locations, a location A 290a, a location B 290b, and a merchant location 292. Location A 290a and location B 290b may be set as delivery locations for packages, such as package 130a and package 130b, respectively. Delivery person 104a and delivery person 104b may be established as delivery persons for package 180a and package 130b, respectively, by a shipping service provider (not shown). As shown in environment 200, delivery person 104a has arrived at location A 290a with package 130a and is in possession of delivery person device 140a. When arriving at location A 290a, a wireless beacon (not shown but corresponding to the described hardware and software of wireless beacon 132 of FIG. 1) inside package 130a may establish location information for package 130a, for example, by connecting with communication device 110a in possession of user 102 and/or a station wireless beacon 134a established at location A 290a. Thus, the wireless beacon may determine a location for package 130a. Delivery information for package 130a may be established with the wireless beacon as location A 290a. Thus, since the location information determined by the wireless beacon matches the delivery location for package 130a, delivery instructions for package 130a at location A 290a may be communicated to delivery person 104a. For example, user 102a may wish for delivery person 104a to call user 102a so that user 102a may meet delivery person 104a at location A 290a. Thus, delivery person 104a may view a contact number for user 102a on delivery person device 140a and call user 102a through communication device 110a. User 102a may also set further delivery instructions for delivery person 140a and/or the shipping provider may determine additional delivery instructions.

However, delivery person 104b is shown as remote from location B 290b. A wireless beacon (not shown but corresponding to the described hardware and software of wireless beacon 132 of FIG. 1) placed inside of package 140b may be utilized to determine that location information for package 130b does not match the delivery location established with delivery information for package 130b. For example, a location detection module for the wireless beacon may determine that GPS coordinates or other location information does not match (e.g., is at or nearby) location B 290b. In other embodiments, because the wireless beacon has not formed a connection with communication device 110b in possession of user 102b and/or a wireless beacon 134b established at or associated with location B 290b, it may be determined that the wireless beacon, and thus package 130b, is not at or nearby location B 290b. Thus, delivery person 104b may not receive and/or view any delivery instructions for package 130b on delivery person device 130b to prevent confusion or incorrect instructions.

In location B 290b, user 102b is in possession of wireless beacon 132a taken from package 130c, for example, after package 130c is delivered to user 102b. User 102b may utilize wireless beacon 132a when shipping another package, such as a return package to a merchant or a package to another user/merchant (e.g., if user 102b sells an item on a marketplace). User 102b may utilize communication device 110b to set new delivery information, including a delivery location, and delivery instructions at the delivery location for wireless beacon 132a. User 102b may then add wireless beacon 132a to a box or package and ship the package, using wireless beacon 132a to convey the delivery instructions at or nearby the delivery location.

A merchant 206 is shown at merchant location 292 where merchant 206 may ship one or more items, for example, to users 102a and/or 102b. Merchant 206 may place wireless beacon 132b in a package 130d for shipment to a purchasing user and set delivery information and/or instructions using merchant device 250. On shipment of package 130d, merchant 206 may lose possession of wireless beacon 132b, which may be kept by a user and used with another shipment, for example, to another user or merchant. However, merchant 206 may be credited with an account credit, which may come in the form of a shipping credit or amount or a credit for use of another wireless beacon. In this way, merchant 206 may not lose value when release control of wireless beacon 132b.

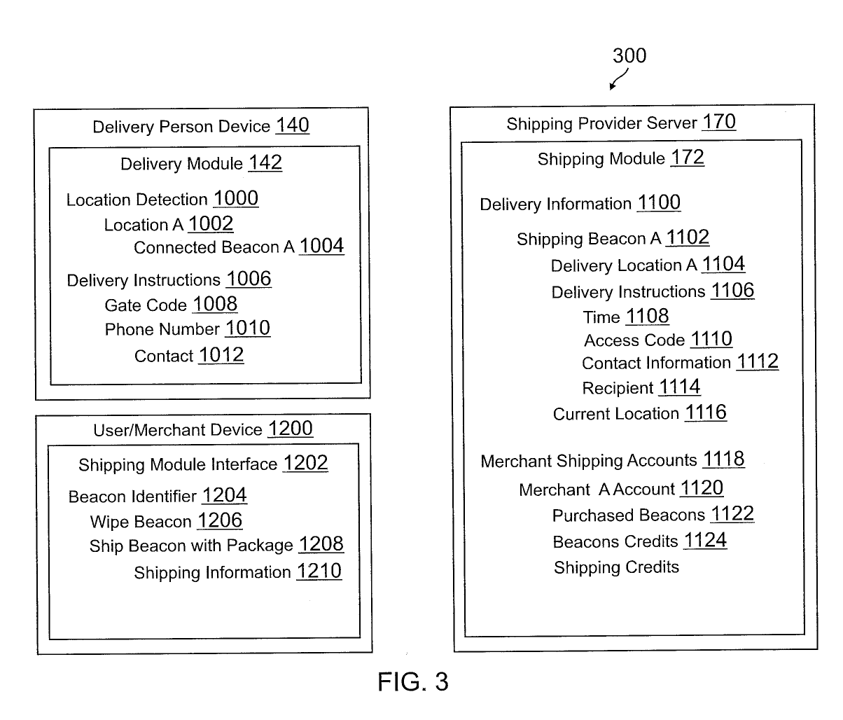

FIG. 3 is an exemplary system environment having a shipping provider server establishing delivery instructions for wireless beacons and utilizing merchant accounts for use of the wireless beacons and shipping, according to an embodiment. Environment 300 includes delivery person device 140 and shipping provider server 170 of FIG. 1. The below described hardware and/or software modules execute functions as described herein with respect to environment 100.

In environment 300, delivery person device 140 executes delivery module 142 having specialized hardware and/or software modules and processes described herein in reference to FIG. 1. Delivery module 142 may be utilized to populate delivery instructions for a package (not shown) in possession of a delivery person (not shown) associated with delivery person device 140. The delivery instructions may be presented when a wireless beacon (not shown) for the package is detected at the delivery location for the package. In order to establish delivery instruction for presentation on delivery person device 140 when the package is detected at or nearby the delivery location through the wireless beacon, a merchant and/or user may set a delivery location and instructions with shipping provider server 170. Shipping provider server 170 executes shipping module 172 having specialized hardware and/or software modules and processes described herein in reference to FIG. 1. In this regard, shipping module 172 includes delivery information 1100, which may be used with the wireless beacon in the package to communicate delivery instructions to delivery person device 140. Delivery information 1100 includes shipping beacon A 1102, which may correspond to an identifier for the wireless beacon in the package. Shipping beacon A 1102 is further associated with information for delivery location A 1104, which may be set by the merchant/user for delivery of the package having shipping beacon A 1102. Further information may include delivery instructions 1106, which may be set by the merchant/user and/or determined by shipping module 172, for example, using past delivery information. Thus, delivery instructions 1106 may include a time 1108 for delivery, an access code 1110 required during delivery, contact information 1112 for contact of a recipient of a package, and/or recipient 1114 of the package. Moreover, shipping module 172 may also receive current location 1116 of the package, in various embodiments, to determine whether to communicate delivery instructions 1106 to delivery person device 140. However, in other embodiments, the wireless beacon may store delivery instructions 1106 and use current location 1116 to match to delivery location A 1104.

Once current location 1116 matches delivery location A 1104, delivery instructions 1106 appear through an interface of delivery module 142. Delivery module 142 displays location detections 1000, which may be received from the wireless beacon in the package or detected through a device module. Location detection 1000 includes a location A 1002 and a connected beacon A 1004 established at location A 1002 (e.g., not the wireless beacon in the package). Thus, current location 1116 may correspond to location A 1002 determined from a connection between connected beacon A 1004 and the package's wireless beacon. Delivery instructions 1106 may populate through delivery module 142 as the necessary instructions for delivery of the package. Thus, delivery instructions 1006 shown in delivery module 142 may correspond to some or all of the set delivery instructions 1106 of shipping module 172. Delivery instructions 1006 are shown as only including gate code 1008 for access to a property or location and phone number 1010 having contact 1012 for contacting the recipient.

In various embodiments, shipping module 172 may also include merchant shipping accounts 1118, which may be used with a merchant device, such as user/merchant device 1200 in order to provide a shipping account to the merchant where the merchant may purchase shipping and/or wireless beacons, as well as receive account credits. Thus, merchant shipping accounts 1118 includes a merchant A account 1120, which may include information for purchased beacons 1122. Purchased beacons 1122 may include identifiers allowing for recognition of beacons. Beacon credits 1124 in merchant A account 1120 may be given based on lost wireless beacons, and may also include account credits to receive shipping and/or new wireless beacons. For example, beacon credits 1124 may also be utilized to generate shipping credits 1126.

User/merchant device 1200 may execute modules discussed in reference to communication device 110 and/or merchant server 150 of FIG. 1 in order to allow for reuse of the wireless beacon used with a package, for example, using an interface of shipping module 172. In this regard, user/merchant device 1200 includes a shipping module interface 1202 allowing for reuse of the wireless beacon by setting new delivery information and/or instructions for use of the wireless beacon. Shipping module interface 1202 includes a beacon identifier 1204 for the wireless beacon, as well as options to wipe beacon 1206 of past delivery information and/or instructions. Once the user/merchant is ready to ship the beacon, the user/merchant may set information under ship beacon with package 1208, such as shipping information 1210 when reusing the wireless beacon.

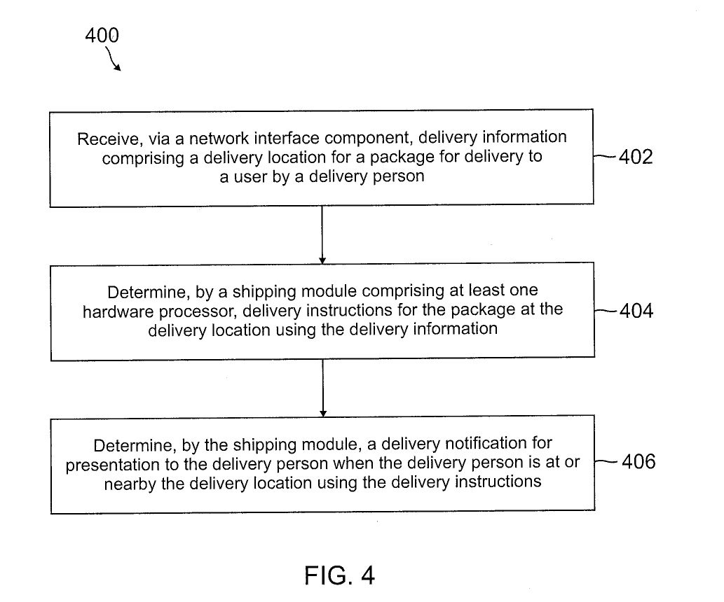

FIG. 4 is a flowchart of an exemplary process for delivery instructions on delivery location detection through a wireless beacon device, according to an embodiment. Note that one or more steps, processes, and methods described herein may be omitted, performed in a different sequence, or combined as desired or appropriate.

At step 402, delivery information comprising a delivery location for a package for delivery to a user by a delivery person is received, via a network interface component. Delivery instruction for the package at the delivery location is determined, by a shipping module comprising at least one hardware processor, using the delivery information, at step 404. The delivery instructions may comprise a time for delivery of the package, a sub-location at the delivery location for delivery of the package, a recipient of the package at the delivery location, a second delivery location for delivery of the package, contact information for the recipient of the package at the delivery location, a drop-off location for the package within the delivery location, and an access code to access the delivery location. The network interface component may further receive additional delivery information comprising a change to the delivery information, wherein the shipping module further determines the delivery instructions using the additional delivery information. For example, an update to the delivery information may be received, wherein the update comprises at least one of a new delivery location for the package, a new recipient for the package, a new time of delivery of the package, and new contact information for use during delivery of the package. Thus, the delivery instructions may be determined using the update. The update may be received from one of a merchant device for a merchant shipping an item to the user using the package and a second communication device in possession of the user.

A delivery notification for presentation to the delivery person when the delivery person is at or nearby the delivery location is determined, by the shipping module, using the delivery instructions, at step 406. The delivery person may be detected at or nearby the delivery location using a wireless beacon associated with the package, such as in, on, attached to, or otherwise associated with the package. For example, the wireless beacon may comprise a transceiver, wherein the wireless beacon utilizes the transceiver to connect with at least one of a communication device at the location and a second wireless beacon established at the location using short range wireless communications with the at least one of the communication device and the second wireless beacon in order to determine that the package, and thus the delivery person, is at or nearby the delivery location. The short range wireless communications may use one of near field communications, radio communications, infrared communications, Bluetooth communications, Bluetooth Low Energy (BLE) communications, WiFi communications, and LTE Direct communications. The communication device as the delivery location may be possession of one of the first user at the delivery location and a second user associated with the first user at the delivery location. For example, the first user may establish the second user as a delivery recipient for the package. In other embodiments, the wireless beacon may detect the package at the delivery location using one of a GPS module, a compass module, and a transceiver connected to another type of beacon or device at the delivery location through short range wireless communications.

The delivery notification may be communicated to a communication device for the delivery person on detection of the location of the package (e.g., the wireless beacon's location information) matching the delivery location. The delivery notification may also be communicated to the wireless beacon in the package on detection of the location matching the delivery location, wherein the wireless beacon communicates the delivery notification to a communication device for the delivery person using short range wireless communications. In other embodiments, the delivery notification may be communicated to the wireless beacon associated with the package, wherein the wireless beacon stores the delivery notification, and wherein the wireless beacon communicates the delivery notification to a communication device in possession of the delivery person on detection by the wireless beacon of the package at or nearby the delivery location.

In various embodiments, the shipping module may further provide a shipping interface for shipping the package with the wireless beacon, wherein the merchant accesses the shipping interface to associate the wireless beacon with the package. Thus, the merchant may receive the wireless beacon from one of a second user in a return package, a second merchant, and a shipping provider associated with the delivery person. The user may access the shipping interface to disassociate the wireless beacon with the package, wherein the user utilizes the shipping interface to associate the wireless beacon with a return package for the merchant. The merchant may receive a shipping account credit with a shipping provider associated with the delivery person if a second merchant receives the wireless beacon from the user. The shipping account credit may comprise one of an amount for use in shipping with the shipping provider and a credit for purchase or use of another wireless beacon with the shipping provider.

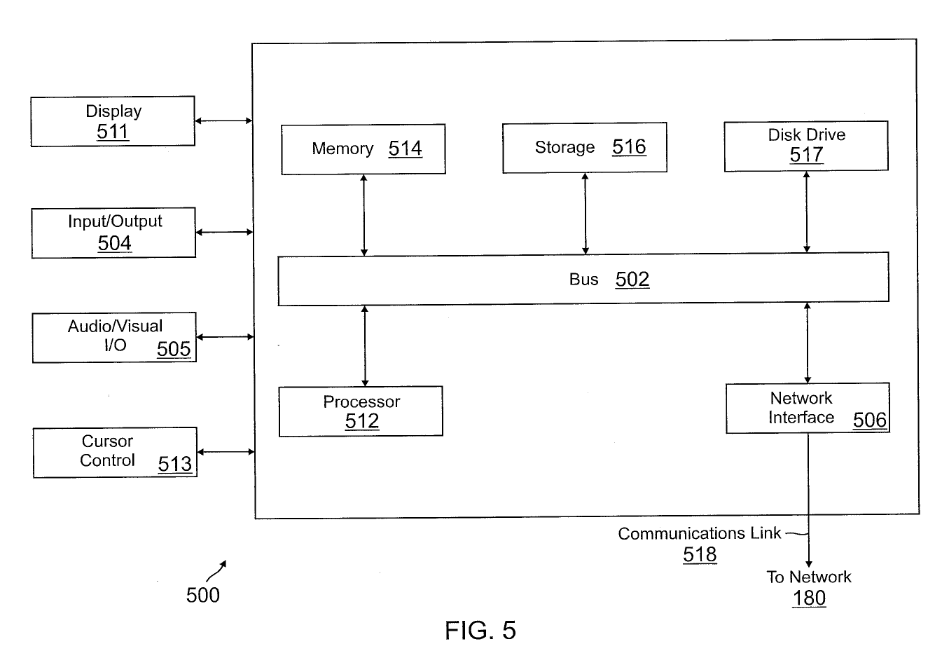

FIG. 5 is a block diagram of a computer system suitable for implementing one or more components in FIG. 1, according to an embodiment. In various embodiments, the user device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another user device, service device, or a service provider server via network 180. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a shipping module comprising at least one hardware processor that accesses delivery information comprising a first delivery location for a package for delivery to a first user by a delivery person; accesses location information comprising a location of the package, wherein the location information is determined by a first wireless beacon associated with the package, determines delivery instructions for the package at the first delivery location using at least one of the delivery information, and determines a delivery notification for presentation to the delivery person when the delivery person is at or nearby the first delivery location using the delivery instructions;
a database stored to a non-transitory memory comprising the delivery location information, the location information, and the delivery notification; and
a network interface component that receives the delivery information from a merchant device for a first merchant shipping the package to the first user, receives the location information from the first wireless beacon, and communicates the delivery notification for the presentation to the delivery person on detection of the location of the package matching the first delivery location.

2. The system of claim 1, wherein the wireless beacon comprises a transceiver, and wherein the wireless beacon utilizes the transceiver to connect with at least one of a communication device at the location and a second wireless beacon established at the location using short range wireless communications with the at least one of the communication device and the second wireless beacon.

3. The system of claim 2, wherein the short range wireless communications use one of near field communications, radio communications, infrared communications, Bluetooth communications, Bluetooth Low Energy (BLE) communications, WiFi communications, and LTE Direct communications.

4. The system of claim 2, wherein the communication device is in possession of one of the first user at the first delivery location and a second user associated with the first user at the first delivery location.

5. The system of claim 4, wherein the first user establishes the second user as a delivery recipient for the package.

6. The system of claim 1, wherein the delivery instructions comprise a time for delivery of the package, a sub-location at the first delivery location for delivery of the package, a recipient of the package at the first delivery location, a second delivery location for delivery of the package, contact information for the recipient of the package at the first delivery location, a drop-off location for the package within the first delivery location, and an access code to access the first delivery location.

7. The system of claim 1, wherein the network interface component further receives additional delivery information comprising a change to the delivery information, and wherein the shipping module further determines the delivery instructions using the additional delivery information.

8. The system of claim 1, wherein the delivery notification is communicated to a communication device for the delivery person on detection of the location matching the first delivery location.

9. The system of claim 1, the delivery notification is communicated to the first wireless beacon on detection of the location matching the first delivery location, and wherein the first wireless beacon communicates the delivery notification to a communication device for the delivery person using short range wireless communications.

10. The system of claim 1, wherein the shipping module further provides a shipping interface for shipping the package with the first wireless beacon, and wherein the first merchant accesses the shipping interface to associate the first wireless beacon with the package.

11. The system of claim 10, wherein the first user accesses the shipping interface to disassociate the first wireless beacon with the package, and wherein the first user utilizes the shipping interface to associate the first wireless beacon with a return package for the merchant.

12. The system of claim 10, wherein the first merchant receives the first wireless beacon from one of a second user in a return package, a second merchant, and a shipping provider associated with the delivery person.

13. The system of claim 1, wherein the first merchant receives a shipping account credit with a shipping provider associated with the delivery person if a second merchant receives the first wireless beacon from the first user.

14. The system of claim 13, wherein the shipping account credit comprises one of an amount for use in shipping with the shipping provider and a credit for purchase or use of a second wireless beacon with the shipping provider.

15. A method comprising:
receiving, via a network interface component, delivery information comprising a delivery location for a package for delivery to a user by a delivery person;
determining, by a shipping module comprising at least one hardware processor, location specific delivery instructions for the package at the delivery location using the delivery information;
determining, by the shipping module, a delivery notification for presentation to the delivery person when the delivery person is at or nearby the delivery location using the location specific delivery instructions; and
communicating, via the network interface component, the delivery notification to a wireless beacon associated with the package, wherein the wireless beacon stores the delivery notification, and wherein the wireless beacon communicates the delivery notification to a first communication device in possession of the delivery person on detection by the wireless beacon of the package at or nearby the delivery location.

16. The method of claim 15, wherein the wireless beacon detects the package at the delivery location using one of a GPS module, a compass module, and a transceiver connected to a device at the delivery location through short range wireless communications.

17. The method of claim 15, wherein the wireless beacon communicates the delivery notification to the first communication device using short range wireless communications with the first communication device.

18. The method of claim 15, wherein prior to the determining the location specific delivery instructions, the method further comprises:
receiving, via the network interface component, an update to the delivery information, wherein the update comprises at least one of a new delivery location for the package, a new recipient for the package, a new time of delivery of the package, and new contact information for use during delivery of the package,
wherein the delivery notification is further determined using the update.

19. The method of claim 18, wherein the update is received from one of a merchant device for a merchant shipping an item to the user using the package and a second communication device in possession of the user.

20. A non-transitory computer-readable medium comprising executable modules which, in response to execution by a computer system, cause the computer system to perform a method comprising:
receiving, by a network interface component, delivery information comprising a delivery location for a package for delivery to a user by a delivery person;
determining, by a shipping module comprising at least one hardware processor, location specific delivery instructions for the package at the delivery location using the delivery information;
determining, by the shipping module, a delivery notification for presentation to the delivery person when the delivery person is at or nearby the delivery location using the location specific delivery instructions; and
communicating, by the network interface component, the delivery notification to a wireless beacon associated with the package, wherein the wireless beacon stores the delivery notification, and wherein the wireless beacon communicates the delivery notification to a communication device in possession of the delivery person on detection by the wireless beacon of the package at or nearby the delivery location.
